(19) United States
(12) Patent Application Publication
(10) Pub. No.: US 2003/0029559 A1
(43) Pub. Date: Feb. 13, 2003

(54) Adhesive for connecting electrodes and adhesion methods with the use of the same

(75) Inventors: Yukio Yamada, Tochigi (JP); Masao Saito, Tochigi (JP); Osamu Takamatsu, Tochigi (JP); Tomoyuki Ishimatsu, Tochigi (JP)

Correspondence Address: OLIFF & BERRIDGE, PLC, P.O. BOX 19928, ALEXANDRIA, VA, 22320, US

(73) Assignee: SONY CHEMICAL CORP.

(21) Appl. No.: 09/795,140

(22) Filed: Mar. 1, 2001

(30) Foreign Application Priority Data
Mar. 7, 2000 (JP) 2000-061548
Mar. 29, 2000 (JP) 2000-090197

(51) Int. Cl. B32B 31/26; C09J 1/00

(52) U.S. Cl. 156/307.7; 156/327

(57) ABSTRACT

Insulating adhesives or adhesive films which ensure both of sufficient repairability and continuity reliability and connection methods with the use of the same are provided.

By using an insulating adhesive 10 comprising a component curing in the low temperature side having a radical polymerization thermosetting mechanism and a component curing in the high temperature side having an epoxy thermosetting mechanism, IC chips 30 are primarily compression bonded (tentative compression bonding) to a wiring board 20 at the 80% reaction temperature of the component curing in the low temperature side. Subsequently, the IC chips 30 are secondarily compression bonded (final compression bonding) to the wiring board 20 at the 80% reaction temperature of the component curing in the high temperature side.

### FIELD OF THE INVENTION

This invention relates to adhesion techniques whereby. for example, boards are fixed to each other and electrodes are electrically connected to each other simultaneously.

### BACKGROUND OF THE INVENTION

To fix, for example, electrodes on a wiring board to electrodes of an IC chip in an electrically connected state, it has been a practice to employ adhesive materials such as an anisotropic conductive paste wherein conductive particles are dispersed in an insulating adhesive, an anisotropic conductive film formed by shaping such a paste into a film, an insulating adhesive free from conductive particles and the like.

In case where an IC chip is mounted on a board by using such an adhesive, the adhesive material is sandwiched between the electrodes on the board and the IC chip and heated under pressing to thereby cured the resin component. Alternatively, the resin component of the adhesive is cured by ultraviolet-irradiation in some cases.

By thus curing the adhesive, the IC chip is fixed to the board and, at the same time, the electrodes are connected to each other.

In case where plural bare chips (IC chips) are mounted on a board as in a multichip module, examination should be carried out each time an IC chip is mounted. In such a case, therefore, the above-described process is divided into two steps, namely, the tentative connection step wherein the adhesive is semi-cured and thus the IC chips are tentatively connected to the board, and the final connection step wherein the semi-cured adhesive is completely cured so as to finally connect the IC chips to the board.

When an IC chip is rejected in the examination in the tentative connection step, then the rejected IC chip is removed and replaced by a good one (i.e., so-called repairing).

The conventional adhesives are roughly classified into three types, namely, thermoplastic adhesives, thermosetting adhesives and ultraviolet-curing adhesives. In addition, the conventional adhesives include so-called semi-thermosetting adhesives having properties intermediate between the thermoplastic type and the thermosetting type and composite adhesives in which the properties of the thermosetting type and the properties of the ultraviolet-curing-type are blended.

When electrodes are connected by using these conventional adhesives, however, there arise the following problems.

In case of using a thermoplastic adhesive, an IC chip can be easily removed from a board in repairing (i.e., showing a favorable repairability) but only a poor continuity reliability can be achieved in thermo-compression due to the poor heat resistance of the adhesive.

In case of using a thermosetting adhesive, a high continuity reliability can be achieved but the repairability is worsened when the adhesive is completely thermoset. To ensure a sufficient repairability by interrupting the thermosetting reaction, various conditions (heating temperature, heating time, etc.) should be controlled. In addition, these conditions vary from board to board, which makes it difficult to handle the adhesive.

In case of using a semi-thermosetting adhesive, the repairability is improved compared with the case of using a thermosetting adhesive but the continuity reliability is more insufficient.

In case of using an ultraviolet-curing adhesive or a composite adhesive, an UV-irradiator should be employed for the ultraviolet-irradiation in addition to a press. Moreover, this UV-irradiator is usable exclusively for the above-described purpose, which brings about another problem that the application range is restricted.

The present invention, which has been completed in order to solve these problems encountering in the related art, aims at providing adhesives for connecting electrodes which ensure both of sufficient repairability and continuity reliability and are applicable for various purposes.

### SUMMARY OF THE INVENTION

The present invention, which has been completed in order to achieve the above-described object, relates to an insulating adhesive for fixing boards to each other and, at the same time, electrically connecting electrodes to each other by placing between the electrodes on the boards facing each other under pressing or pressing and heating, characterized in that the adhesive includes plural adhesive components having different thermosetting mechanisms.

In this case, it is effective that the insulating adhesive according to the present invention includes two adhesive components having different thermosetting mechanisms.

In the insulating adhesive according to the present invention, it is effective that the difference between the Differential Scanning Calorimetry (DSC) exothermic peak temperatures of the two adhesive components is 20° C. or more.

In an insulating adhesive according to the present invention, it is also effective that the two adhesive components comprise a component curing in the low temperature side and another component curing in the high temperature side, and the 80% reaction temperature of the component curing in the low temperature side is 100° C. or higher while the 80% reaction temperature of the component curing in the high temperature side is 140° C. or higher, as in the present invention.

In an insulating adhesive according to the present invention, it is also effective that one of the adhesive components comprises a resin having a radical polymerization thermosetting mechanism with the use of a peroxide, and the other of the two adhesive components comprises a resin having an epoxy thermosetting mechanism.

On the other hand, the present invention relates to an anisotropic conductive adhesive characterized by having conductive particles dispersed in an insulating adhesive.

The invention relates to an insulating adhesive film characterized in that it is formed by shaping the above-described insulating adhesive into a thin film.

In this case, it is also effective in the insulating adhesive film according to the present invention that plural layers comprising plural adhesive components having different thermosetting mechanisms are formed in the invention.

The present invention relates to an anisotropic conductive adhesive film characterized by having conductive particles dispersed in an insulating adhesive film as described above.

On the other hand, the present invention relates to a method of connecting electrodes on boards, characterized by comprising placing an insulating adhesive as above described between electrodes on boards facing each other; heating the insulating adhesive at the 80% reaction temperature of one of the plural adhesive components under pressure; and then heating the insulating adhesive at the 80% reaction temperature of the other of the plural adhesive components under pressure.

The present invention relates to a method of connecting electrodes on boards, characterized by comprising placing the above-described anisotropic conductive adhesive between electrodes on boards facing each other; heating the anisotropic conductive adhesive at the 80% reaction temperature of one of the plural adhesive components under pressure; and then heating the anisotropic conductive adhesive at the 80% reaction temperature of the other of the plural adhesive components under pressure.

Further, the present invention relates to a method of connecting electrodes on boards, characterized by comprising placing the above-described insulating adhesive film between electrodes on boards facing each other; heating the insulating adhesive film at the 80% reaction temperature of one of the plural adhesive components under pressure; and then heating the insulating adhesive film at the 80% reaction temperature of the other of the plural adhesive components under pressure.

Furthermore, the present invention relates to a method of connecting electrodes, characterized by comprising placing the above-described anisotropic conductive adhesive film between electrodes on boards facing each other; heating the anisotropic conductive adhesive film at the 80% reaction temperature of one of the plural adhesive components under pressure; and then heating the anisotropic conductive adhesive film at the 80% reaction temperature of the other of plural adhesive components under pressure.

In the present invention, the tentative connection is first carried out by heating to such a temperature as allowing the thermosetting of the component curing in the low temperature side of the adhesive to a certain stage (for example, the 80% reaction temperature) and thus the boards are fixed tentatively to each other. Then an examination (for example, a continuity test) is performed.

In this state, the component curing in the low temperature side has not completely thermoset and the component curing in the high temperature side does not undergo the thermosetting reaction yet. Thus, a board rejected in the examination, if any, can be easily removed.

After tentatively connecting the thus examined boards to each other, the final connection is performed at such a temperature as allowing the thermosetting of the component curing in the high temperature side (for example, the 80% reaction temperature or higher). Thus, both of the component curing in the low temperature side and the component curing in the high temperature side thermoset and the boards are completely fixed to each other thereby.

As described above, the present invention makes it possible to provide adhesives for connecting electrodes which ensure both of sufficient repairability and continuity reliability.

By using the adhesives according to the present invention, moreover, connection can be carried out merely by heat compression bonding without resort to any special apparatuses such as an UV irradiator. Thus, the adhesives of the present invention have an additional merit of being widely applicable.

### BRIEF DESCRIPTION OF THE DRAWINGS

FIGS. 1(a) and 1(b) are schematic views each showing the constitution of a preferred mode of the embodiment of the insulating adhesive film according to the present invention.

FIGS. 2(a) and 2(b) are schematic views each showing the constitution of the anisotropic conductive adhesive film according to the present invention.

FIGS. 3(a) to 3(e) show the process of a preferred embodiment of the connection method with the use of the adhesive for connecting electrodes according to the present invention.

In these figures, each numerical symbol has the following meaning.

1A, 1B: insulating adhesive film

1C, 1D: anisotropic conductive adhesive film

2: release film

10: insulating adhesive layer

11a, 11b: component curing in the low temperature side

12: component curing in the high temperature side

13: conductive particle.

### DETAILED DESCRIPTION OF THE INVENTION

Now, the mode for carrying out the present invention will be described in greater detail by reference to the attached drawings.

The insulating adhesive according to the present invention is to be located between electrodes on boards facing each other under pressing optionally with heating, thereby fixing boards to each other and, at the same time, electrically connecting electrodes to each other.

The term “board” as used herein involves circuit boards such as so-called mother boards and daughter boards as well as electronic parts such as IC chips.

The insulating adhesive according to the present invention is characterized by including two or more (plural) adhesive components having different thermosetting mechanisms.

Next, a case of using two adhesive components having different thermosetting mechanisms, which are referred to as the component curing in the low temperature side and the component curing in the high temperature side respectively, will be illustrated by way of example.

By taking the reactivity of adhesive components into consideration, the thermosetting mechanism of an adhesive component is specified by using its DSC exothermic peak and 80% reaction temperature.

The term “DSC exothermic peak” as used herein means a temperature determined by differential scanning calorimetry (DSC) which is a method wherein a difference in heat input/output between a sample and a standard put in a temperature controlled electric furnace and the sample temperature are measured.

The term “80% reaction temperature” as used herein means a temperature at which an adhesive reacts at a level of 80% or more after compression bonding for a predetermined period of time (for example, 10 seconds).

This 80% reaction temperature is calculated based on the DSC exothermic peak value after curing a sample by referring the initial DSC exothermic peak value of the adhesive component to be measured as to 100%.

By considering the reactivities in the tentative compression bonding and the final compression bonding, it is preferable in the present invention that the difference between the DSC exothermic peak temperatures of the component curing in the low temperature side and the component curing in the high temperature side is 20° C. or more, more preferably 30° C. or more.

From the viewpoint of ensuring sufficient storage stability and reactivity, it is preferable to use as the component curing in the low temperature side a component having a DSC exothermic peak of 60 to 140° C., more preferably 80 to 130° C.

From the viewpoint of ensuring sufficient workability and connection reliability, it is preferable to use as the component curing in the high temperature side a component having a DSC exothermic peak of 80 to 170° C., more preferably 100 to 150° C.

From the viewpoint of ensuring sufficient workability, on the other hand, it is preferable to use as the component curing in the low temperature side a component having an 80% reaction temperature after compression bonding for 10 seconds of 100° C. or higher, more preferably 110° C. or higher.

From the viewpoint of ensuring sufficient workability and connection reliability, it is preferable to use as the component curing in the high temperature side a component having an 80% reaction temperature after compression bonding for 10 seconds of 140° C. or higher, more preferably 150° C. or higher.

Considering the reaction speed and the storage stability, it is appropriate in the present invention to use as the component curing in the low temperature side, for example, an acrylate-base adhesive having a radical polymerization thermosetting mechanism with the use of a peroxide.

From the viewpoint of ensuring sufficient connection reliability and reaction speed, on the other hand, it is appropriate to use as the component curing in the high temperature side, for example, an adhesive having an epoxy thermosetting mechanism with the use of a latent curing agent.

In this case, it is preferable to regulate the content of the component curing in the low temperature side to 5 to 70 parts by weight, more preferably 10 to 50 parts by weight, per 100 parts by weight of the total amount of the component curing in the low temperature side and the component curing in the high temperature side.

When the content of the component curing in the low temperature side is less than 5 parts by weight, there arises a problem that the continuity cannot be surely maintained in the step of the tentative compression bonding. When its content exceeds 70% by weight, on the other hand, there arises another problem that the connection reliability is worsened after the completion of the curing.

Next, the mode of a preferred embodiment of the adhesive film according to the present invention will be illustrated by reference to the attached drawings.

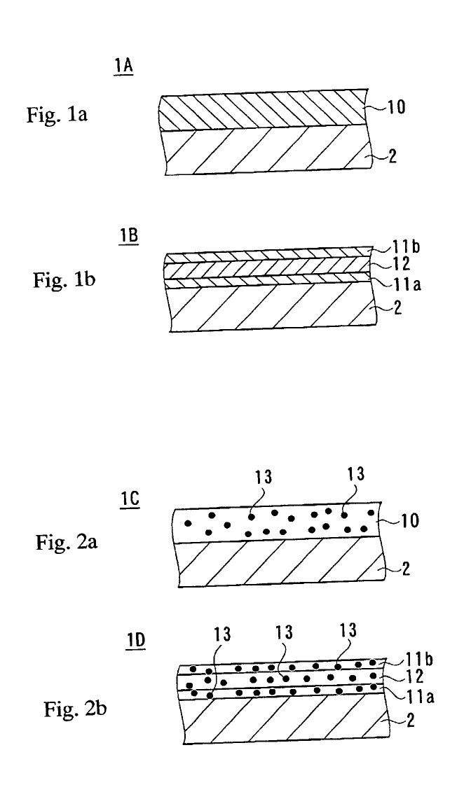

FIGS. 1(a) and 1(b) are schematic views each showing the constitution of a preferred mode of the embodiment of the insulating adhesive film according to the present invention. FIGS. 2(a) and 2(b) are schematic views each showing the constitution of the anisotropic conductive adhesive film according to the present invention.

The insulating adhesive film 1A as shown in FIG. 1(a) consists of a release film 2 made of, for example, a polyester resin and an insulating adhesive layer 10 formed thereon which comprises two adhesive components having different thermosetting mechanisms as described above.

In this case, it is preferable for various uses that the thickness of the insulating adhesive layer 10 ranges from 5 to 100 μm, though the present invention is not restricted thereto.

The insulating adhesive film 1A of this embodiment mode can be formed by a conventional method. That is to say, it can be obtained by dissolving the two adhesive components as described above in a predetermined solvent and applying the thus obtained binder paste on the release film 2 followed by drying.

On the other hand, the insulating adhesive film 1B as shown in FIG. 1(b) consists of a release film 2, a layer 11a of a component curing in the low temperature side, a layer 12 of a component curing in the high temperature side and another layer 11b of a component curing in the low temperature side formed thereon.

In this case, it is preferable from the viewpoint of ensuring sufficient connection reliability that the thickness of the layer 11a of the component curing in the low temperature side ranges from 2 to 50 μm, the thickness of the layer 12 of the component curing in the high temperature side ranges from 3 to 100 μm and the thickness of the layer 11b of the component curing in the low temperature side ranges from 2 to 50 μm, though the present invention is not restricted thereto.

The layer 11a of the component curing in the low temperature side, the layer 12 of the component curing in the high temperature side and the layer 11b of the component curing in the low temperature side may be formed in an arbitrary order without restriction. From the viewpoint of ensuring sufficient repairability and characteristics favorable in the step of the tentative compression bonding, it is preferred that the layer 12 of the component curing in the high temperature side is sandwiched between the layers 11a and 11b of the components curing in the low temperature side.

The insulating adhesive film 1B of this embodiment mode can be formed by a conventional method. That is to say, it can be obtained by dissolving the above-described components curing in the low and high temperature sides each in a predetermined solvent and applying the thus obtained binder pastes successively on the release film 2 followed by drying.

On the other hand, the anisotropic conductive adhesive film 1C as shown in FIG. 2(a) has conductive particles 13 dispersed in the insulating adhesive layer 10 of the insulating adhesive film 1A of FIG. 1(a) as described above.

The anisotropic conductive adhesive film 1D as shown in FIG. 2(b) has conductive particles 13 dispersed respectively in the layer 11a of the component curing in the low temperature side, the layer 12 of the component curing in the high temperature side and the layer 11b of the component curing in the low temperature side the insulating adhesive film 1B of FIG. 1(b) as described above

From the viewpoint of ensuring sufficient continuity and insulating characteristics, it is preferable that the content of the conductive particles ranges from 1 to 20% by volume, though the present invention is not restricted thereto.

From the viewpoint of ensuring sufficient continuity reliability, it is preferable that the particle diameter of the conductive particles ranges form 1 to 20 μm, though the present invention is not restricted thereto.

The anisotropic conductive adhesive films 1C and 1D according to the present invention can be formed by a conventional method too. That is to say, each anisotropic conductive adhesive film can be obtained by dissolving the above-described adhesive components respectively in predetermined solvents, dispersing the conductive particles 13 therein and then applying the thus obtained binders on the release film 2 followed by drying.

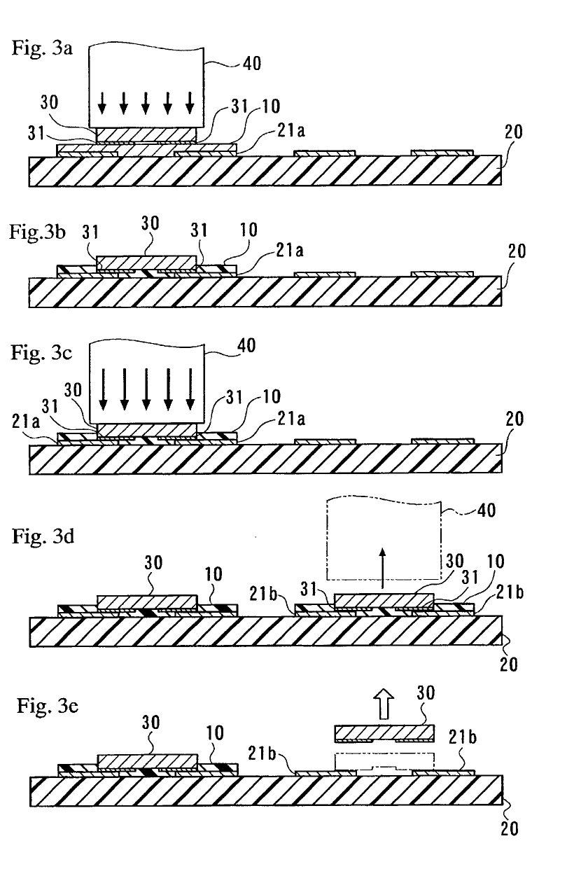

FIGS. 3(a) to 3(e) show the process of a preferred embodiment of the connection method with the use of the adhesive for connecting electrodes according to the present invention. Now, a case of using a conductive particle-free insulating adhesive will be illustrated by way of example.

As FIG. 3(a) shows, the insulating adhesive according to the present invention is applied on an electrode 21a to be connected, which is located on a wiring board 20, and an IC chip 30 is placed on the thus formed insulating adhesive film 10 followed by the positioning of the IC chip 30.

Next, the primary compression bonding (tentative connection) is carried out as the tentative compression bonding under a pressure of, for example, 3 MPa/cm² per bump for 10 seconds by using a compression bonding head 40 which has been controlled so as to achieve the insulating adhesive film 10 temperature corresponding to the 80% reaction temperature (for example, 130° C.) of the component curing in the low temperature side, (FIG. 3(b)).

In this state, the component curing in the low temperature side of the insulating adhesive film 10 has not been completely thermoset, while the component curing in the high temperature side does not undergo the thermosetting reaction yet.

Then a continuity test is performed between the electrodes 21a and 31 which have been thus tentatively connected to each other. In case where favorable results are obtained, the compression bonding head 40 is controlled so that the temperature of the insulating adhesive film 10 is increased to the 80% reaction temperature (for example, 170° C.) of the component curing in the high temperature side or higher and the secondary compression bonding (final connection) is carried out as the final compression bonding under a pressure of, for example, 3 MPa/cm² per bump for 10 seconds.

Thus, the component curing in the low temperature side and the component curing in the high temperature side of the insulating adhesive film 10 thermoset, thereby completely fixing the boards to each other.

Subsequently, another IC chip 30 is tentatively compression bonded to another electrode 21b on the wiring board 20 in the same manner (i.e., the primary compression bonding) and then a continuity test is performed in the above-described manner.

In this state, the component curing in the low temperature side of the insulating adhesive film 10 has not been completely thermoset, while the component curing in the high temperature side does not undergo the thermosetting reaction yet, as described above. If the IC chip 30 is rejected as the results of the continuity test, it can be easily removed from the wiring board 20, as shown in FIG. 3(e).

Then another IC chip 30 is tentatively compression bonded in the above-described manner and subjected to the continuity test again. In case where favorable results are obtained, the final compression bonding is then carried out in the above-described manner.

Subsequently, IC chips 30 are tentatively contact bonded to the electrodes 21a and 21b on the wiring board 20 and the continuity test is carried out. Next, repairing is performed if necessary and thus IC chips 30 showing favorable results are exclusively compression bonded finally to the wiring board 20.

As described above, the embodiment mode of the present invention makes it possible to ensure both of sufficient repairability and the conductive reliability in the step of mounting the IC chips 30 on the wiring board 20.

By using the insulating adhesive of this embodiment mode, moreover, the connection can be carried out merely by heat compression bonding, which brings about another merit that no special apparatus such as an UV irradiator is needed.

In the embodiment mode as described above, the case of using a conductive particle-free insulating adhesive has been illustrated by way of example. Also, connection can be performed in the same manner in case of using an anisotropic conductive adhesive or an anisotropic conductive adhesive film including conductive particles.

In the embodiment mode as described above, the case of using an adhesive including two adhesive components having different thermosetting mechanisms has been illustrated by way of example. Also, the present invention is applicable to adhesives including three or more adhesive components having different thermosetting mechanisms.

Now, the invention will be described in greater detail by reference to the following Examples and Comparative Examples.

First, adhesives A-1 to A-3 having a radical polymerization thermosetting mechanism and another adhesive B having an epoxy thermosetting mechanism were prepared as the components to be used in the insulating adhesives of Examples and Comparative Examples, as shown in Table 1.

<Adhesive A-1>

A blend was prepared by using 15 parts by weight of bisphenol F-type ethylene oxide (EO)-modified diacrylate (M-208™, manufactured by Toagosei Chemical Industry Co., Ltd.) as an insulating adhesive resin and 5 parts by weight of 1,1,3,3-tetramethylbutyl peroxy-2-methylhexanate (PEROCTA O™, manufactured by Nippon Oil and Fats Co., Ltd.) as an initiator.

This adhesive A-1 has a DSC exothermic peak of 80° C. and an 80% reaction temperature of 130° C.

<Adhesive A-2>

A blend was prepared by using 15 parts by weight of the above-described bisphenol F-type ethylene oxide (EO)-modified diacrylate as an insulating adhesive resin and 5 parts by weight of t-butyl peroxybenzoate (PERBUTYL Z™, manufactured by Nippon Oil and Fats Co., Ltd.) as an initiator.

This adhesive A-2 has a DSC exothermic peak of 100° C. and an 80% reaction temperature of 150° C.

<Adhesive A-3>

A blend was prepared by using 15 parts by weight of the above-described bisphenol F-type ethylene oxide (EO)-modified diacrylate as an insulating adhesive resin and 5 parts by weight of an organic peroxide (PERCURE HB™, manufactured by Nippon Oil and Fats Co., Ltd.) as an initiator.

This adhesive A-3 has a DSC exothermic peak of 120° C. and an 80% reaction temperature of 170° C.

<Adhesive B>

A blend was prepared by using 50 parts by weight of a solid bisphenol A-type epoxy resin (solid epoxy resin: EP1009™ manufactured by Yuka Shell Epoxy K.K.) as an insulating adhesive resin, 50 parts by weight of an imidazole-based curing agent (HX3941HP™ manufactured by Asahi Chemical Industry Co., Ltd.) as a latent curing agent and 1 part by weight of epoxysilane (A187™ manufactured by Nippon Unicar Co., Ltd.) as a coupling agent.

This adhesive B has a DSC exothermic peak of 120° C. and an 80% reaction temperature of 170° C.

TABLE 1
Composition of adhesive

| | | | DSC | 80% Reaction |
|---|---|---|---|---|
| | | Content | exothermic | temperature/ |
| | | (wt. part) | peak (° C.) | time |
| Adhesive A-1 | Bisphenol F EO-modified diacrylate | 15 | 80° C. | 130° C. |
| | 1,1,3,3-tetra-methylbutyl | 5 | | 10 S |
| | peroxy-2-methylhexanate | | | |
| Adhesive A-2 | Bisphenol F EO-modified diacrylate | 15 | 100° C. | 150° C. |
| | t-butyl peroxybenzoate | 5 | | 10 S |
| Adhesive A-3 | Bisphenol F EO-modified diacrylate | 15 | 120° C. | 170° C. |
| | Organic peroxide | 5 | | 10 S |
| Adhesive B | Solid epoxy resin | 50 | 120° C. | 170° C. |
| | Latent curing agent | 50 | | 10 S |
| | Epoxysilane | 1 | | |

Then the samples of Examples 1 to 4 and the samples of Comparative Examples 1 to 5 were prepared by using the adhesives A-1 to A-3 and the adhesive B at various contents.

### EXAMPLE 1

To a binder solution including 5 parts by weight of the adhesive A-1 and 95 parts by weight of the adhesive B, 15 parts by weight of conductive particles were added to give a paste. Thus the sample of Example 1 was prepared.

### EXAMPLE 2

The sample of Example 2 was prepared as in Example 1 but using 25 parts by weight of the adhesive A-1 and 75 parts by weight of the adhesive B.

### EXAMPLE 3

The sample of Example 3 was prepared as in Example 1 but using 70 parts by weight of the adhesive A-1 and 30 parts by weight of the adhesive B.

### EXAMPLE 4

The sample of Example 4 was prepared as in Example 1 but using 25 parts by weight of the adhesive A-1 and 75 parts by weight of the adhesive A-2.

### COMPARATIVE EXAMPLE 1

The sample of Comparative Example 1 was prepared as in Example 1 but using 100 parts by weight of the adhesive A-1 with no adhesive B.

### COMPARATIVE EXAMPLE 2

The same sample as in Example 4 was employed as the sample of Comparative Example 2.

### COMPARATIVE EXAMPLE 3

The sample of Comparative Example 3 was prepared as in Example 1 but using 25 parts by weight of the adhesive A-1 and 75 parts by weight of the adhesive A-3.

### COMPARATIVE EXAMPLE 4

The sample of Comparative Example 4 was prepared as in Example 1 but using 100 parts by weight of the adhesive B with no adhesive A-1.

### COMPARATIVE EXAMPLE 5

The same sample as in Comparative Example 4 was employed as the sample of Comparative Example 5.

<Evaluation method and evaluation result>

(Continuity resistance after primary compression bonding)

Each of the above-described samples was applied on a wiring board in such a manner as to give a thickness after drying of 40 μm. After positioning, IC chips were primarily compression bonded to the wiring board (tentative compression bonding).

In this case, use was made as the wiring board of a rigid board which had been prepared by forming a copper (Cu) pattern (thickness: 18 μm, width: 100 μm, pitch: 150 μm) on a heat-resistant glass base-epoxy resin copper-clad laminate (FR-5) and then plating with nickel-gold.

On the other hand, use was made as the IC chips of those having bump electrodes (20 μm×20 μm in outer size, height: 20 μm) formed on a board (10 mm×10 mm in outer size). The bump electrodes were plated with nickel-gold.

In Examples 1 to 3 and Comparative Examples 1 and 2, the primary compression bonding was carried out at a temperature of 130° C. under a pressure of 3 MPa/cm² per bump for 10 seconds.

In Example 4 and Comparative Example 5, the primary compression bonding was carried out at a temperature of 150° C. under a pressure of 3 MPa/cm² per bump for 10 seconds.

In Comparative Examples 3 and 4, the primary compression bonding was carried out at a temperature of 170° C. under a pressure of 3 MPa/cm² per bump for 10 seconds.

After the completion of the primary compression bonding, continuity resistance was measured between every pair of electrodes.

A sample showing a continuity resistance less than 100 mΩ was evaluated as good (◯), one showing a continuity resistance of from 100 to 500 mΩ was evaluated as somewhat poor (Δ), and one showing a continuity resistance exceeding 500 mΩ was evaluated as poor (X). Table 2 summarizes the results.

(Repairability)

On a metal plate heated to 100° C., the above-described wiring board having the IC chips primarily compression bonded thereto was placed and heated for 30 seconds. Then the IC chips were released and the residue of the sample of each Example or Comparative Example was wiped off from the wiring board by using acetone.

The repairability of a case wherein the IC chips could be released and the sample residue could be completely eliminated was evaluated as good (◯), the repairability of one wherein the IC chips could be released but the sample residue could not be completely eliminated was evaluated as somewhat poor (Δ), and the repairability of one wherein the IC chips could be hardly released was evaluated as poor (X). Table 2 summarizes the results.

(Continuity resistance after secondary compression bonding)

After the completion of the primary compression bonding, the samples of Examples and Comparative Examples were subjected to the secondary compression bonding (final compression bonding) under predetermined conditions.

In Comparative Example 1, the secondary compression bonding was carried out at a temperature of 150° C. under a pressure of 3 MPa/cm² per bump for 10 seconds.

In Examples 1 to 4 and Comparative Examples 2 to 5, the secondary compression bonding was carried out at a temperature of 170° C. under a pressure of 3 MPa/cm² per bump for 10 seconds.

After the completion of the secondary compression bonding, the continuity resistance was measured between every pair of electrodes.

A sample showing a continuity resistance less than 100 mΩ was evaluated as good (◯). one showing a continuity resistance of from 100 to 500 mΩ was evaluated as somewhat poor (Δ), and one showing a continuity resistance exceeding 500 mΩ was evaluated as poor (X). Table 2 summarizes the results.

(Continuity reliability after PCT)

A pressure cooker test (PCT) was carried out at a temperature of 121° C., under a humidity of 100% RH and under a pressure of 2 atm. Subsequently, the continuity resistance was measured between every pair of electrodes.

Similar to the above-described case, a sample showing a continuity resistance less than 100 mΩ was evaluated as good (◯), one showing a continuity resistance of from 100 to 500 mΩ was evaluated as somewhat poor (Δ), and one showing a continuity resistance exceeding 500 mΩ was evaluated as poor (X). Table 2 summarizes the results.

TABLE 2
Evaluation results of Examples and Comparative Examples

| | | | | | | Continuity | | Continuity | | Primary | Secondary |
|---|---|---|---|---|---|---|---|---|---|---|---|
| | | | | | | resistance | | resistance | | compression | compression |
| | | | | | | after primary | | after secondary | Continuity | bonding | bonding |
| | Adhesive | | | Adhesive | Conductive | compression | | compression | reliability | Temp. | Temp. |
| | A-1 | A-2 | A-3 | B | particles | bonding | Repairability | bonding | after PCT | Time | Time |
| C. ex. 1 | 100 | — | — | — | 15 | ◯ | Δ | ◯ | X | 130° C. | 150° C. |
| | | | | | | | | | | 10 s | 10 s |
| Ex. 1 | 5 | — | — | 95 | 15 | Δ | ◯ | ◯ | ◯ | 130° C. | 170° C. |
| | | | | | | | | | | 10 s | 10 s |
| Ex. 2 | 25 | — | — | 75 | 15 | ◯ | ◯ | ◯ | ◯ | 130° C. | 170° C. |
| | | | | | | | | | | 10 s | 10 s |
| Ex. 3 | 70 | — | — | 30 | 15 | ◯ | ◯ | ◯ | Δ | 130° C. | 170° C. |
| | | | | | | | | | | 10 s | 10 s |
| Ex. 4 | 25 | 75 | — | — | 15 | ◯ | ◯ | ◯ | ◯ | 150° C. | 170° C. |
| | | | | | | | | | | 10 s | 10 s |
| C. ex. 2 | 25 | 75 | — | — | 15 | X | ◯ | ◯ | ◯ | 130° C. | 170° C. |
| | | | | | | | | | | 10 s | 10 s |
| C. ex. 3 | 25 | — | 75 | — | 15 | ◯ | X | ◯ | ◯ | 170° C. | 170° C. |
| | | | | | | | | | | 10 s | 10 s |
| C. ex. 4 | — | — | — | 100 | 15 | ◯ | X | ◯ | ◯ | 170° C. | 170° C. |
| | | | | | | | | | | 10 s | 10 s |
| C. ex. 5 | — | — | — | 100 | 15 | X | ◯ | ◯ | ◯ | 150° C. | 170° C. |
| | | | | | | | | | | 10 s | 10 s |

As Table 2 shows, the samples of Examples 1 to 4 showed favorable results both in repairability and continuity reliability.

In contrast thereto, the sample of Comparative Example 1 with the use of the adhesive A-1 alone showed a poor continuity reliability after PCT.

In Comparative Example 2 wherein the primary compression bonding temperature was the same as the 80% reaction temperature of the adhesive A-1, the adhesive A-2 could not sufficiently cure and thus only a poor continuity resistance was achieved after primary compression bonding.

In Comparative Example 3 wherein the primary compression bonding was performed at a high temperature (170° C.), the adhesives A-1 and A-3 reacted and cure in the course of the primary compression bonding, which worsened the repairability.

In Comparative Example 4 with the use of the adhesive B alone, the adhesive B reacted in the course of the primary compression bonding, which worsened the repairability.

In Comparative Example 5 wherein the same components were used as in Comparative Example 4 but the primary compression bonding was carried out at a lower temperature, on the other hand, the adhesive B could not sufficiently cure. As a result, only a poor continuity resistance was achieved after the primary compression bonding.

As discussed above, the present invention makes it possible to provide adhesives for connecting electrodes which ensure both of sufficient repairability and continuity reliability and are applicable for various purposes.

What is claimed is:

1. An insulating adhesive for electrically connecting electrodes on boards to each other which includes plural adhesive components having different thermosetting mechanisms.

2. The insulating adhesive as claimed in claim 1 which includes two adhesive components having different thermosetting mechanisms.

3. The insulating adhesive as claimed in claim 2 wherein the difference between the DSC exothermic peak temperatures of said two adhesive components is 20° C. or more.

4. The insulating adhesive as claimed in claim 2, wherein said two adhesive components comprise a component curing in the low temperature side and another component curing in the high temperature side, and the 80% reaction temperature of said component curing In the low temperature side is 100° C. or higher while the 80% reaction temperature of said component curing in the high temperature side is 140° C. or higher.

5. The insulating adhesive as claimed in claim 3, wherein said two adhesive components comprise a component curing in the low temperature side and another component curing in the high temperature side, and the 80% reaction temperature of said component curing in the low temperature side is 100° C. or higher while the 80% reaction temperature of said component curing in the high temperature side is 140° C. or higher.

6. The insulating adhesive as claimed in claim 5, wherein one of the two adhesive components comprises a resin having a radical polymerization thermosetting mechanism with the use of a peroxide, and the other of said two adhesive components comprises a resin having an epoxy thermosetting mechanism.

7. An anisotropic conductive adhesive for electrically connecting electrodes on boards to each other comprising,
an insulating adhesive including two adhesive components comprising a component curing in the low temperature side which has an 80% reaction temperature of 100° C. or higher and another component curing in the high temperature side which has an 80% reaction temperature of 140° C. or higher, and conductive particles dispersed in said insulating adhesive.

8. The anisotropic conductive adhesive as claimed in claim 7, wherein one of the two adhesive components comprises a resin having a radical polymerization thermosetting mechanism with the use of a peroxide, and the other of said two adhesive components comprises a resin having an epoxy thermosetting mechanism.

9. An insulating adhesive film for electrically connecting electrodes on boards to each other, which is formed by shaping into a thin film an insulating adhesive including two adhesive components comprising a component curing in the low temperature side which has an 80% reaction temperature of 100° C. or higher and another component curing in the high temperature side which has an 80% reaction temperature of 140° C. or higher.

10. The insulating adhesive film as claimed in claim 9, wherein one of the two adhesive components comprises a resin having a radical polymerization thermosetting mechanism with the use of a peroxide, and the other of said two adhesive components comprises a resin having an epoxy thermosetting mechanism.

11. The insulating adhesive film as claimed in claim 9, which comprises plural layers comprising plural adhesive components having different thermosetting mechanisms.

12. An anisotropic conductive adhesive film for electrically connecting electrodes on boards to each other, which is formed by shaping into a thin film an insulating adhesive including two adhesive components comprising a component curing in the low temperature side which has an 80% reaction temperature of 100° C. or higher and another component curing in the high temperature side which has an 80% reaction temperature of 140° C. or higher, and having conductive particles dispersed therein.

13. An anisotropic conductive adhesive film as claimed in claim 12, wherein one of the two adhesive components comprises a resin having a radical polymerization thermosetting mechanism with the use of a peroxide, and the other of said two adhesive components comprises a resin having an epoxy thermosetting mechanism.

14. A method of connecting electrodes on boards, which comprises placing an insulating adhesive including plural adhesive components having different thermosetting mechanisms between electrodes on boards facing each other; heating said insulating adhesive at the 80% reaction temperature of one of said plural adhesive components under pressure; and then heating said insulating adhesive at the 80% reaction temperature of the other of said plural adhesive components under pressure.

15. A method of connecting electrodes on boards, which comprises placing an anisotropic conductive adhesive including plural adhesive components having different thermosetting mechanisms between electrodes on boards facing each other; heating said anisotropic conductive adhesive at the 80% reaction temperature of one of said plural adhesive components under pressure; and then heating said anisotropic conductive adhesive at the 80% reaction temperature of the other of said plural adhesive components under pressure.

16. A method of connecting electrodes on boards, which comprises placing an insulating adhesive film including plural adhesive components having different thermosetting mechanisms between electrodes on boards facing each other; heating said insulating adhesive film at the 80% reaction temperature of one of said plural adhesive components under pressure; and then heating said insulating adhesive film at the 80% reaction temperature of the other of said plural adhesive components under pressure.

17. A method of connecting electrodes on boards, which comprises placing an anisotropic conductive adhesive film including plural adhesive components having different thermosetting mechanisms between electrodes on boards facing each other; heating said anisotropic conductive adhesive film at the 80% reaction temperature of one of said plural adhesive components under pressure; and then heating said anisotropic conductive adhesive film at the 80% reaction temperature of the other of said plural adhesive components under pressure.
